(19) United States
(12) Patent Application Publication
(10) Pub. No.: US 2020/0068262 A1
(43) Pub. Date: Feb. 27, 2020

(54) System and method for sharing content in a live stream and story application

(71) Applicants: Santino Anthony Saldana, Taylor, MI (US); Robert Swihart, Taylor, MI (US)

(72) Inventors: Santino Anthony Saldana, Taylor, MI (US); Robert Swihart, Taylor, MI (US)

(21) Appl. No.: 16/111,254

(22) Filed: Aug. 24, 2018

(51) Int. Cl. H04N 21/4788; H04N 21/81; H04N 21/4782; H04N 21/2187

(52) U.S. Cl. CPC H04N 21/4788; H04N 21/2187; H04N 21/4782; H04N 21/8173

(57) ABSTRACT

A novel form of mobile application technology which has a dynamic workflow integrated with a multiple network to form a integrated processing framework. The system has been built into a network where the live stream interface allows users to go live on multiple live stream providers simultaneously or by specific selection. An integrated mobile platform where users are able to stream live on all social media platforms or the ones they have selected by specific social media API. Furthermore, the story interface allows users to record a video clip for few seconds and share with selected social media API's.

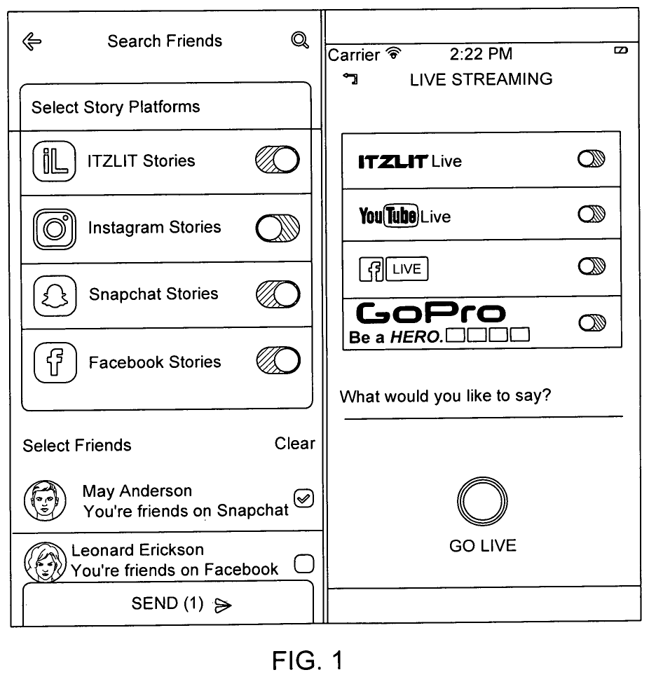

### BACKGROUND

### Field of the Invention

The present invention relates generally to social media. More specifically, the present invention is a system and method for sharing content in a live stream and story application.

### Description of the Related Art

Existing methods of sharing content is fragmented. Different services have their own applications and it's difficult to share to multiple platforms at the same time, especially for live video.

There are multiple inventions that have been found in prior art providing the system for transferring the videos and live streaming to friends and family. For instance, a Sip network-based content sharing method and system bearing US patent

US2,009,028,200,5A1 is issued to Samsung Electronics Co Ltd. The invention depicts a content sharing method and system are provided such that a first client stores a content in one of its local storage and a content server and a second client requests from an information server one of a query and subscription of the content and downloads the content from the respective one of the local storage of the first client and the content server with reference to the respective one of the query and subscription result sent by the information server. In the content sharing method a first client stores a content in a content server or a local storage and assigns a content IDentifier (ID) to the content, creates a content list having content items each identified by a unique content ID, and registers the content list and an access rule with an information server, and the information server sends, when a second client requests one of a query and a subscription of the content, a respective one of a query result and a subscription result to the second client in consideration of a second client's access right specified in the access rule.

A US Patent 2,009,004,4216A1 is an internet-Based System for Interactive Synchronized Shared Viewing of Video Content. The invention discloses an internet-based viewing system for interactive synchronized shared viewing of video content comprises a website accessible to customers of the viewing system and providing mechanisms for the customers to select, author and schedule viewing sessions for transmission by the system, to invite other customers to view selected viewing sessions in synchronicity as a shared viewing group while allowing interactive communication between the customers within the viewing group. The system website provides mechanisms for providers of video content and customers to author viewing programs and makes them available to customers on the system website. Advertisements and/or interactive components may be included in the viewing programs as part of the authoring processes.

A US patent 2,009,013,1177A1 issued to Daybreak Game Co LLC is a system and method for creating, editing, and sharing video content relating to video game events. Systems and methods are provided for at least partially automating generation of video clips chronicling a character's interaction with a video game. The same may combine automatic video clip generation with automatic or user-generated and/or user-edited or created narrative. Multiple video clips may be combined into a video reel prior to or subsequent to uploading the same to a file-sharing site. The video game may be a massive multiplayer online role-playing game.

A US Patent US2,009,004,4216A1 is an internet-Based System for Interactive Synchronized Shared Viewing of Video Content. Internet-based viewing system for interactive synchronized shared viewing of video content comprises a website accessible to customers of the viewing system and providing mechanisms for the customers to select, author and schedule viewing sessions for transmission by the system, to invite other customers to view selected viewing sessions in synchronicity as a shared viewing group while allowing interactive communication between the customers within the viewing group. The system website provides mechanisms for providers of video content and customers to author viewing programs and makes them available to customers on the system website. Advertisements and/or interactive components may be included in the viewing programs as part of the authoring processes.

A US Patent 2,008,011,2315A1 is a peer-to-peer aided live video sharing system issued to Microsoft Corp. The system incorporates a video data from an upload client is received at a hosting node. A request from a download client is received at a bootstrapping node to receive the video data. The download client to receive the video data directly from the hosting node when the hosting node is below a threshold, wherein the threshold is based at least in part on the maximum number of download clients the hosting node can stream to simultaneously. The download client to receive the video data from peers in a peer-topeer overlay when the hosting node above the threshold.

A Method, system and visual phone for sharing the image and/or video data bearing Canadian Patent CN1,010,352,48A is issued to a Chinese Inventor. The invention provides a method for sharing picture and/or video data between video phone user terminals, comprising: transmitting-side vide phone or receiving-side video phone starts picture and/or video data sharing; the transmitting-side video phone reads the picture and/or video data and transmits the picture and/or video data through network-side equipment to the receiving-side video phone; the receiving-side video phone receives the picture and/or video data from the network-side equipment and displays pictures and/or plays video. And the invention also provides a video phone and a communication system. And the invention effectively solves the problem of real-time communication in the picture and/or video data sharing course, and users can make real-time voice call to evaluate the picture and/or video data, thus improving users' experience.

The WO2009094611A2 patent discloses a system and method for creating, editing, and sharing video content relating to video game events . It discloses systems and methods which are provided for at least partially automating generation of video clips chronicling a character's interaction with a video game. The same may combine automatic video clip generation with automatic or user-generated and/or user-edited or created narrative. Multiple video clips may be combined into a video reel prior to or subsequent to uploading the same to a file-sharing site. The video game may be a massive multiplayer online roleplaying game.

A CN103209360A invention discloses a multi-party video sharing method and device system. An embodiment of the invention provides a multi-party video sharing method and device. The multi-party video sharing method includes initiating a multi-party video sharing request to called terminals; determining time difference between a home terminal and the called terminals according to received response determining receiving time of the called terminals; and determining the sharing video synchronized playing time of the called terminals and the home terminal according to the time difference. By adopting the multi-party video sharing method, system time between a calling terminal and all the called terminals can be corrected, the calling terminal and the called terminals can keep in accordance in aspect of the playing schedule of the same sharing video, and the effect that the playing schedule time is completely synchronous is achieved. In addition, the problem that the calling terminal and the called terminals are not synchronous in video playing due to communication time delay can be solved.

A US20120260298A1 issued to ZTE Corp discloses a method and system for sharing video among mobile terminals. The present invention provides method and system for sharing video among mobile terminals. The method comprises: a calling terminal uploads a video file to a media server; a called terminal establishes a video link with the media server through a mobile network; the media server sends a video stream to the called terminal through the video link; the called terminal receives the video stream from the media server and plays the video file. The method and system provided by the present invention enable simultaneous sharing of the same video among multiple called terminals and enable a called terminal to watch the same shared video multiple times, therefore not only time and labour are saved, but also user experience is enhanced. By playing shared video through a mobile network, stream media is played directly and more smoothly, and problems of video buffering and video stagnating in video sharing are solved.

It is therefore an objective of the proposed invention to introduce a system and method for sharing live streams and stories across multiple platforms simultaneously. The system proposes an advancement in a web-based computer programming that can be deployed within a personal network and that can assist in sharing stories across multiple platforms simultaneously.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a system and procedure for sharing content and stories across multiple platforms simultaneously.

Another objective of the invention is to utilize social media application programming interfaces with addition to web server functionality via mobile app, comprising the distributing of live stream feeds and advertisement clip once live stream ends.

It is further the objective of the invention to provide ease of use to the consumer.

It is also the objective of the invention to provide simultaneous retransmission of the streaming live function to the social media application programming interfaces and also the transmission of this live stream feed via mobile device/web applications.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

All illustrations of the drawings are for the purpose of describing selected versions of the present invention and are not intended to limit the scope of the present invention. The present invention is a method and system for sharing live stream social media and story content. According to one embodiment by utilizing social media application programming interfaces with addition to web server functionality via mobile app comprises the distributing of live stream feeds and advertisement clip once live stream ends.

According to one embodiment a computer-implemented server and app based method comprises logging content accessed by a first client. A list of accessible social media API's are updated and provided to the first client. Request is received by this client and implemented on mobile application for live stream broadcasting of video and upload of story content such as pictures and videos for social media events. A request is received by this client and implemented on mobile application for live stream broadcasting of video and upload of content such as pictures and videos for social media stories. This system and method contains a mobile interface for receiving the video stream of a live event extensively and can be distributed selectively or simultaneously with the recording of the video stream from a server to the broadcast by utilization of social media application programming interfaces. Mobile interfaces include live stream and story for social media

API's. Simultaneous retransmission of the streaming live function includes multiple video streams to the social media application programming interfaces and transmission of this live stream feed via mobile device/web. Story interface includes the same mashup concept of social media API integrations for upload of user content such as pictures and videos to selected social media platforms.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE IMAGES

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the images, showing only those specific details that are pertinent to understanding the embodiments of the present invention so as not to obscure the disclosure with details that will be readily apparent to those of ordinary skill in the art having the benefit of the description herein.

Image 1 shows how our Invention works;

Image 2 another view of our Invention;

Image 3 shows our Invention;

Image 4 shows another view how our Invention works;

Image 5 shows live request.

I: The present invention is a web-based system that can be deployed within a mobile network, that can be configured using a dynamic workflow to upload the story content such as pictures and videos for social media events;
A web based mobile application according to claim I, where Mobile app for users to stream live on all social media platforms simultaneously is implemented;
A web based mobile application according to claim I, where backend system for live Stream allows user to send live 5 streams to widely distributed destinations such as Facebook, YouTube, and other social media API's.

II: A mobile application which allow users to send data to multiple social media API's with a simple interface to use where:
A mobile application for connecting multiple APIs' according to claim II, where a simple Login Page is presented to user;
A mobile application for connecting multiple APIs' according to claim II, where user registers within the app using basic information such as email id, password and name;
A mobile application for connecting multiple APIs' according to claim II, where user chooses social media accounts to login within the app;
A mobile application for connecting multiple APIs' according to claim II, where to perform the connection with other APIs', Social Media Integration is required A mobile application for connecting multiple APIs' according to claim II, where on the dashboard page user will be able to view history of recordings and live broadcast;
A mobile application for connecting multiple APIs' according to claim II, where the user will be able to view the details of the recordings and Live broadcasts;
A mobile application for connecting multiple APIs' according to claim II, where on selecting story interface user records video for clip;
A mobile application for connecting multiple APIs' according to claim II, where once the video is recorded user can see in the video and select option of sharing on social media platforms such as Snapchat, Facebook, Instagram;
A mobile application for connecting multiple APIs' according to claim II, where the user chooses the social media platforms where he/she needs to share the story interface;
A mobile application for connecting multiple APIs' according to claim II, where once the story is shared user gets message saying the video has been shared and would be recorded in history section;
A web based mobile application where the flexible social feed will utilize the arrangement of user stories (pictures and videos) with the integration of video content. The Live content will be arranged in a unique drop-down fashion including a unique Go Live request button. The “Go live” Request Button, will notify another user to Go live with video content on a social media platform or application. Numerical value can record these go live requests or will show other user/friend that requested user to go live using a go live button request or notification.
A Live Button which is when clicked will show user video content on social feed. Furthermore, by utilizing an arrow or swiping gesture it allows users to view more video content.
A one-finger zoom in and out camera technology which replaces the two finger or thumb pinching gesture for zoom in / zoom out on mobile cameras. This can also be used for camera functionality in Story or Live stream web or mobile applications platforms. This is a technological solution by utilizing one finger or thumb gesture to zoom in or out of the mobile phone camera.

III: A web based mobile application which allows simultaneous story/ies upload at multiple platforms simultaneously.
The web based mobile application according to claim VI, where the user can capture a picture or video describing a story and upload to multiple social media platforms simultaneously;
The web based mobile application according to claim VI, where picture or video can also be simultaneously uploaded from one platform to another after posted.
